(19) United States
(12) Patent Application Publication
(10) Pub. No.: US 2009/0013389 A1
(43) Pub. Date: Jan. 8, 2009

(54) SWIFTTRAC JOB TRACKING SERVICE WITH GEOSPATIAL CAPABILITY

(76) Inventor: Perry Pintzow, Albuquerque, NM (US)

Correspondence Address: Ortiz and Lopez, P.O. Box 4484, Albuquerque, NM, 87196-4484, US

(21) Appl. No.: 12/168,618

(22) Filed: Jul. 7, 2008

Related U.S. Application Data
(60) Provisional application No. 60/948,386, filed on Jul. 6, 2007.

(51) Int. Cl. G06F 17/30; G06F 21/00; H04L 9/32; G06F 7/06

(52) U.S. Cl. 726/5; 707/10; 707/3; 707/E17.107

(57) ABSTRACT

Many web sites often serve dynamic web pages based on dynamic data automatically fetched from a database. A service provider can provide authoring tools that enable customers to easily craft pages that include dynamic data. Job tracking and project management are examples of tasks that use dynamic data. A customer using the service provider's tools can easily create web pages for tracking jobs or managing projects. The tools provide for accessing geospatial information systems which are databases that attach data to specific locations. SwiftTrac is an Internet service providing customers with capabilities including job tracking and project management capabilities wherein elements of the project are tied to specific locations. Customers can easily and conveniently create trackers for projects and provide for personnel at remote locations to manipulate tracking data in conformance with each person's permission level.

### CROSS REFERENCE TO RELATED APPLICATIONS

This patent application claims the priority and benefit of U.S. Provisional Patent Application No. 60/948,386 filed on Jul. 6, 2007 entitled “SwiftTrac” and which is incorporated herein by reference in its entirety.

### TECHNICAL FIELD

Embodiments relate to job tracking software and project management software. Embodiments also relate to web services. Embodiments further relate to geospatial data, and geospatial information systems.

### BACKGROUND OF THE INVENTION

When a person accesses a web server, it returns a web page that the person can view in a browser window. Some web pages are static because their specific content was determined at the time the page was authored. Some web pages are dynamic because portions of the page, or perhaps the entire page, are automatically generated from data fetched from a data source. For example, a shopping page can present an item, price, and description using a template a dynamically obtained data.

The dynamically obtained data is obtained from a data source, such as a database. There are many types of database, but one of the most powerful types is the relational database. A relational database stores data in tables. The tables can be associated with one another and with each other's data elements. Many tables have access restrictions that provide data security and prevent unauthorized tampering.

Web site specialists often author dynamic web pages that obtain data from databases. Systems and methods for providing authoring capabilities to nonspecialists are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that a service provider provides a web server that can be access by a user associated with a client of the service provider. The user uses a web browser to access the web server to obtain a presentation that is presented in a browser window.

It is another aspect of the embodiments that a database engine manages a client table and a client data table. Client data tables are associated with client tables. Each client data table is indexed on at least one indexed element.

It is yet another aspect of the embodiments that a client customization module uses client presentation data to customize the presentation for the client. As such, the user obtains a customized presentation.

It is a further aspect of the embodiments that a page generation module discovers a client data table's indexed elements and uses them to produce a criteria presentation. The criteria presentation has at least one criteria selection element corresponding to each of the indexed elements.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates SwiftTrac system in accordance with aspects of the embodiments;

FIG. 2 illustrates an example of a subsystem using a criteria selection module in accordance with aspects of the embodiments;

FIG. 3 illustrates a subsystem for generating predefined reports in accordance with aspects of the embodiments;

FIG. 4 illustrates an automatic report generation subsystem in accordance with aspects of the embodiments;

FIG. 5 illustrates a web browser 507 assembling a report in accordance with aspects of the embodiments;

FIG. 6 illustrates the BINAR main page 600 in accordance with aspects of the embodiments;

FIG. 7 illustrates the PA main page 700 in accordance with aspects of the embodiments;

FIG. 8 illustrates the PA module edit page 800 in accordance with aspects of the embodiments;

FIG. 9 illustrates the claims main page 900 in accordance with aspects of the embodiments;

FIG. 10 illustrates the claims submodule edit page 1000 in accordance with aspects of the embodiments;

FIG. 11 illustrates a blank report edit page 1100 in accordance with aspects of the embodiments;

FIG. 12 illustrates the independents report edit page 1200 in accordance with aspects of the embodiments;

FIG. 13 illustrates a blank submodule edit page 1300 in accordance with aspects of the embodiments;

FIG. 14 illustrates a users edit page 1400 in accordance with aspects of the embodiments;

FIG. 15 illustrates a criteria selector page 1500 in accordance with aspects of the embodiments; and

FIG. 16 illustrates a report page 1600 in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

Many web sites often serve dynamic web pages based on dynamic data automatically fetched from a database. A service provider can provide authoring tools that enable customers to easily craft pages that include dynamic data. Job tracking and project management are examples of tasks that use dynamic data. A customer using the service provider's tools can easily create web pages for tracking jobs or managing projects. The tools provide for accessing geospatial information systems which are databases that attach data to specific locations. SwiftTrac is an Internet service providing customers with capabilities including job tracking and project management capabilities wherein elements of the project are tied to specific locations. Customers can easily and conveniently create trackers for projects and provide for personnel at remote locations to manipulate tracking data in conformance with each person's permission level.

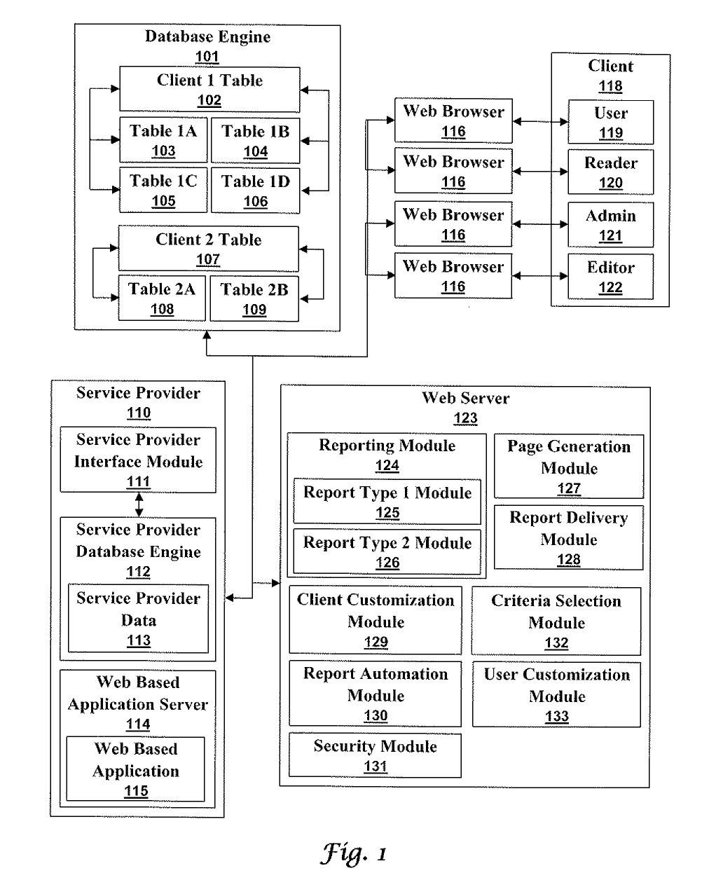

FIG. 1 illustrates SwiftTrac system in accordance with aspects of the embodiments. A database engine 101 can maintain tables for each of a number of clients. A client table such as the client 1 table 102 and client 2 table 107 can contain data about the client such as address, billing, preferred page layout, logo graphics, and text fields. Data tables can be associated with the client tables. Here, table 1A 103, table 1B 104, table 1C 105, and table 1D are associated with client 1 while table 2A 108 and table 2B are associated with client 2.

A user 119 working for or associated with a client 118 can use a web browser 116 to access the database engine 101, a service provider 110, and a web server 123. There can be different types of user 119 such as a reader 120, admin 121, and editor 122. A reader 120 can be limited to reading data, and an admin 121 can edit data in any table associated with the client 118, and an editor 122 can edit data in any data table associated with the client 118.

A service provider 110 can provide data and presentation services. For example, a search engine provides a data service by accepting a search string and returning a list of matching web pages. A mapping service can accept a search string or coordinate data and produce a map. The service provider 110 can supply services in a number of ways. The service provider 110 can provide a web page through which information is accessed. A service provider 110 can provide direct access to a database engine 112 containing service provider data 113. The service provider 110 can serve a web based application 115 that the web browser 116 downloads from a web based application server 114 and then executes. The web based application 115 can directly access the database engine 113 or can access it through a service provider interface module 111. A service provider interface module 111 is a software gateway through which web based applications or other applications can access the services offered by a service provider.

The web server 123 can contain a reporting module 124, a client customization module 129, a report automation module 130, a security module 131, a page generation module 127, a report delivery module 128, a criteria selection module 132, and a user customization module 133. A reporting module accepts data and produces formatted reports. For example, a report type 1 module 125 can produce a pdf file and a report type 2 module 126 can produce an html file that is then published on a web server. The client customization module 129 can access data such as that in client table 1 102 and use that data to customize how data is presented to on behalf of the client. The page generation module 127 can operate in conjunction with the client customization module 129 to automatically generate web pages for viewing by the client's 118 users 119.

A report automation module 130 can automatically generate reports using preselected criteria and report formats. The report automation module 130 can pass reports to a report delivery module 128. The report delivery module 128 can deliver a report to each of a number of people. Different people can receive the report in different manners such as email, as a text message, or as a web page. The user customization module 113 can access a table that specifies user information such as how the user prefers to receive automated reports and initial selections for the user's own reports. The security module 131 can restrict access to the web server and data in the database engine 101. Different users can have different access levels, as discussed earlier with respect to readers, editors, and admins.

The criteria selection module 132 can determine the indexed rows in a database table and interact with the page generation module 127 to produce a custom criteria selection presentation such as a criteria selection web page. A criteria selection page can contain an input for each indexed row in a table and can populate those inputs with selections from the table.

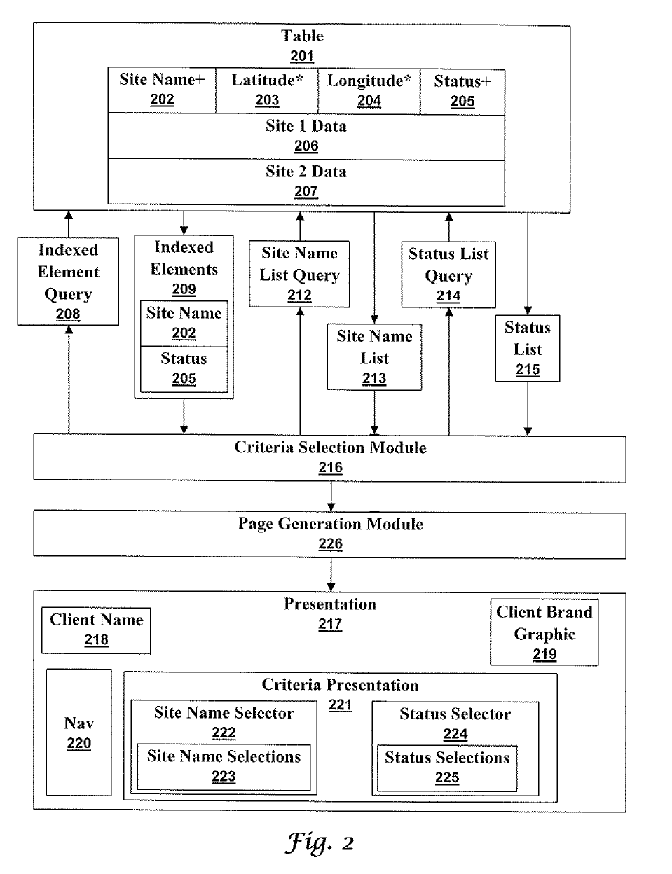

FIG. 2 illustrates an example of a subsystem using a criteria selection module in accordance with aspects of the embodiments. A table 201 contains data about different sites such as site 1 206 and site 2 207. The table rows include site name 202, longitude 204, latitude 203, and status 205. Site name and status 205 are marked with a “+” to indicate they are indexed fields. Longitude 204 and latitude 203 are marked with an “*” to indicate they are flagged fields. Fields can be indexed, flagged, neither, or both.

In general, a criteria selection module formats and sends data queries. It can send SQL formatted queries to an SQL database engine or can use a custom interface for other data services. A criteria selection module 216 can send an indexed element query 208 to obtain a list of indexed elements 209 indicating that site name 202 and status 205 are the indexed elements. The criteria selection module 216 then issues a site name list query 212 and a status list query 214 to obtain lists of different site names 213 and different site statuses 215. The criteria selection module can then use the page generation module 226 to produce a presentation 217. The presentation 217 can include a navigation bar 220, the client name 218, the client brand graphic 219 and a criteria presentation 221. The navigation bar can be automatically generated to indicate the various tables and reports configured by the client. Table 1 201 is one of the clients tables, there can be many more. The client name 218 and client brand graphic 219 can be a text string and a logo image stored in a client table such as the client 1 table 102 of FIG. 1.

The criteria presentation 221 includes a site name selector 222 containing site name selections and a status selector 224 containing status selections. The site name selections 223 are the site names from the site name list 213. The status selections 225 are the statuses from the status list 215.

Flagged elements such as longitude 204 and latitude 203 can indicate that additional options can be presented to the user. For example, coordinates can indicate that the user can request a map showing where sites are located.

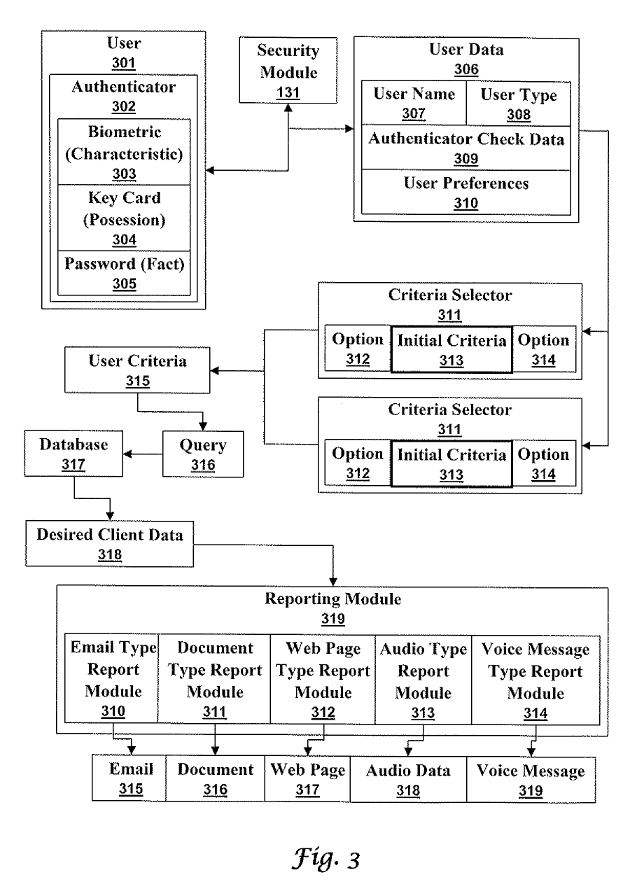

FIG. 3 illustrates a subsystem for generating predefined reports in accordance with aspects of the embodiments. An authenticator 302 is something that helps authenticate a user's 301 identity. A biometric, such as a fingerprint is a characteristic of the user 301. A keycard 304 is a possession of the user 301. A password 305 is a fact known by the user 301. A security module 131 can use any one or combination of characteristics, possessions, and facts to authenticate the user 301 for access to the subsystem. The user 301 is associated with user data 306 that can include the user' name 307 and type 308 such as reader, admin, or editor. Authenticator check data 309 can be used by the security module 131 to authenticate the user. As such, the authenticator check data 309 can include information, possibly encrypted, matching user characteristics, possessions, or knowledge.

User preferences 310 can include the manner in which a user prefers to see a presentation. For example, color blind people prefer color schemes they can perceive and many people are more fluent in one language than in another. User preferences 310 can also include initial criteria 313. A criteria selector 311 can present a user with numerous selectors with each selector having numerous possible selections. Initial criteria 313 can contain the initial settings for at least one of the selectors with the user making selections for other options 312, 314. One obtaining a criteria presentation with initial criteria 313 set, a user can make selections that do not match the initial criteria 313.

A user makes selections with criteria selector 311 and then submits or approves them to produce user criteria 315. The user criteria can be formatted into queries 316 for a database 317 or web based service that result in desired client data 318. The desired client data 318 can be passed to a reporting module 319 and formatted into a report. Different modules can be used to produce different report formats. An email type report module 310 can produce email 315 reports. A documents type report module 311 can produce a document 316 in pdf, word, odf, or some other document format specification. A web page type report module 312 can produce a web page 317 that can be published on a web server. An audio type report module 313 can produce audio data 318 such as a voice, music, or tones. A voice message type report module 314 can produce a voice message 319 that can be forwarded to a voice messaging system.

Alternatively, initial criteria 313 can be used to automatically generate a report. The initial criteria 313 can be automatically accepted as user criteria 315. For example, a user can specify that a report is to automatically issue each day at 7:30 AM. The initial criteria 313 can be automatically used, thereby eliminating the step of presenting a user with a criteria presentation. The process flow from receiving user criteria 315 to issuing a report is fully automated and, as such, the reports are automatically generated and sent out.

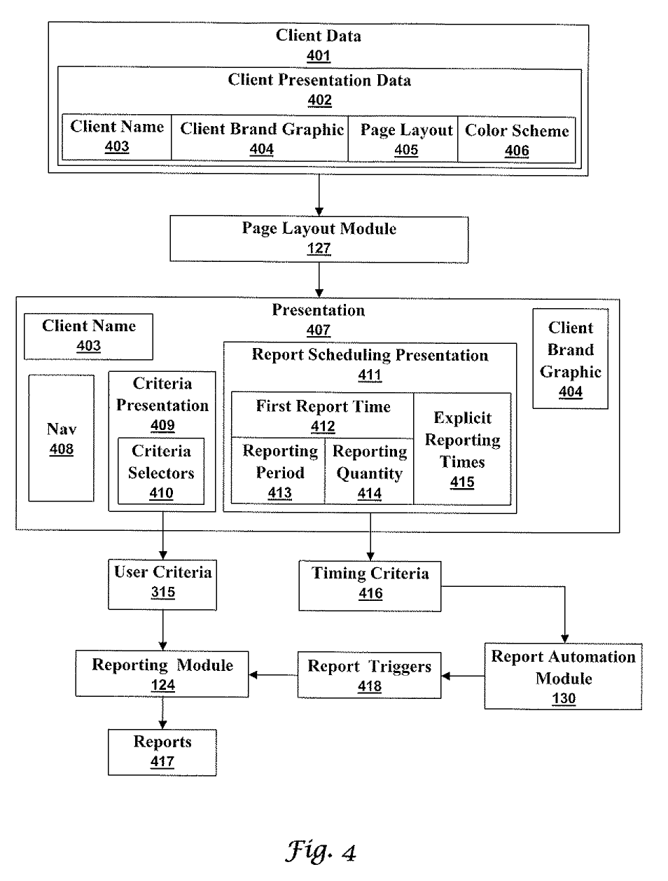

FIG. 4 illustrates an automatic report generation subsystem in accordance with aspects of the embodiments. Client data 401 can include client presentation data 402 such as the client name 403, client brand graphic 404, page layout preferences 405, and color scheme 406. The client data 401 can be passed to a page layout module 127 that produces a presentation 407. As illustrated previously, the presentation 407 can include the client name 403, a navigation bar 408, the client brand graphic 404, and a criteria presentation 409 containing criteria selectors 410. The presentation 407 can also include a report scheduling presentation 411 that can set timing criteria 416 such as a first report time 412, reporting period 413, reporting quantity 414, or explicit reporting times 415. The first report time 412 is the data and time that the first report is to be produced and sent. As such, the first report time 412 is a special case of the explicit reporting times 415 because the explicit reporting times 415 can be a list of times for reports to be produced and sent.

A reporting period 413 is the interval between reports. For example, daily reports can have a 24 hour period. A reporting quantity is the number of times to send a report. For example, a report can have a 7:30 AM Monday first report time, 24 hour period, and reporting quantity of 5. Based on these timing criteria 416, the report automation module 130 will issue a report trigger 418 to the reporting module 124 every day for a week starting Monday at 7:30 AM with the final report trigger 418 sent Friday at 7:30 AM.

Upon receiving a report trigger 418, the reporting module can obtain user criteria 315 and generate reports 417. The user criteria 315 can be stored separately, in association with the timing criteria 416, as initial criteria, or in some other manner.

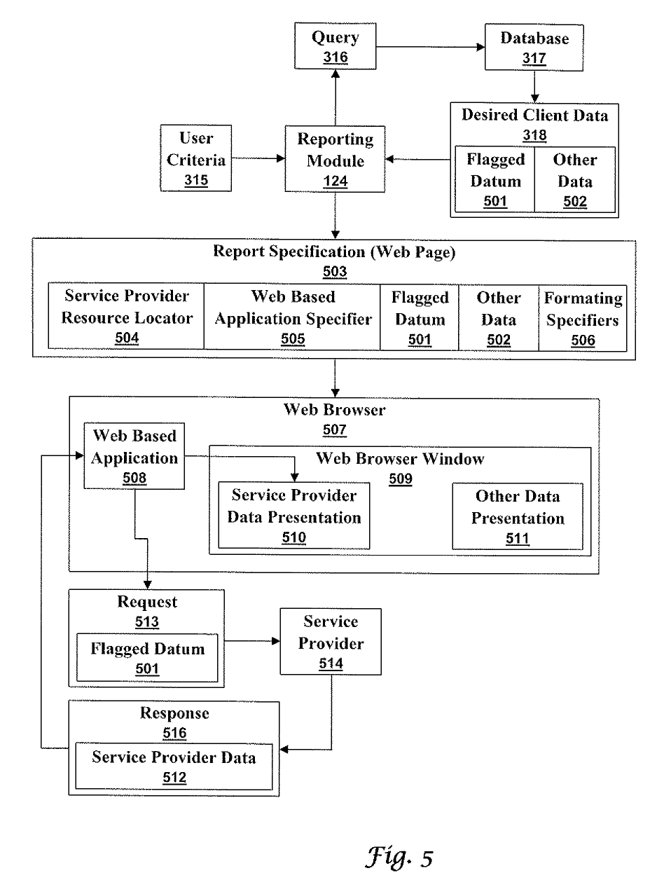

FIG. 5 illustrates a web browser 507 assembling a report in accordance with aspects of the embodiments. The web browser 507 obtains a report specification 503, perhaps in the form of a web page. The report specification 503 can contain a service provider resource locator 504, a web based application specifier 505, a flagged datum 501, other data 502, and formatting specifiers 506. A formatting specifier 506 tells the web browser 507 how to present information in a web browser window 509. A flagged datum is a datum that alerts the web browser to present additional data. For example, most reports can be textual unless a flagged datum indicates that the report should use an alternative format including a graphic.

A web based application specifier 505 can indicate which web based application to obtain and from where to obtain it. The web based application 508 can then be downloaded and run within the browser 507. For example, a web based application can produce a service provider data presentation, such as a map, in the browser window 509. Other data presented 511 in the web browser window 509 can be independent of the web based application 508.

The web based application 508 can send a request 513 to a service provider 514 that in return send a response 516. The request can contain the flagged datum 501. The response 516 can contain service provider data 512 for display within the service provider data presentation 510.

The report specification 503 can be automatically generated. User criteria 315 can be passed to a reporting module 124 such that a query 316 is sent to a database 317 that responds with desired client data 318. The desired client data 318 can contain a flagged datum 501 as well as other data 502. The reporting module 124 formats the desired client data 318 into a report specification 503.

The service provider resource locator 504 direct the web based application 508 to the service provider 514. In some embodiments, there is no web based application. The service provider resource locator can direct the web browser 507 to a service provider 514 from which presentation data is obtained. For example, the service provider 514 can produce an image in response to a request 513 from the web browser 507. The web browser 507 receives the image and presents it as a service provider data presentation 510.

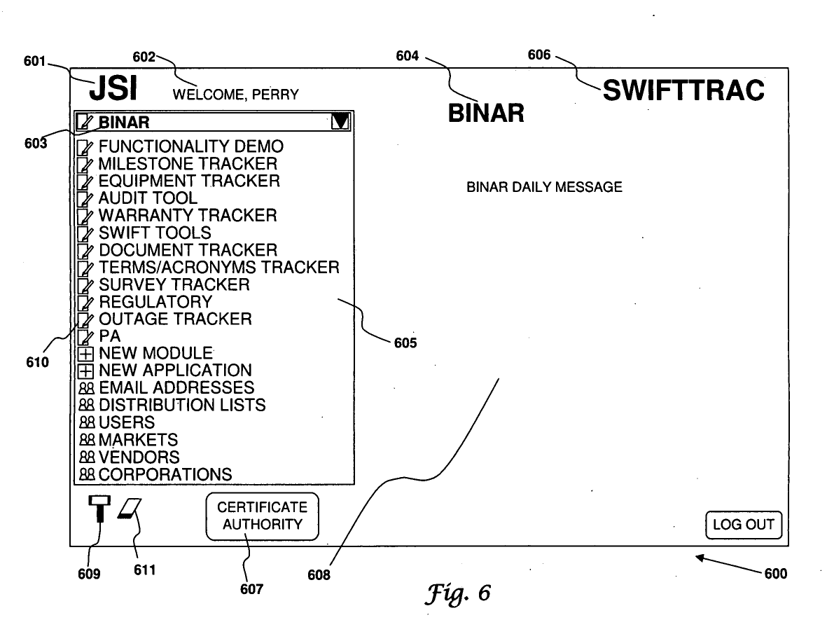

FIG. 6 illustrates the BINAR main page 600 in accordance with aspects of the embodiments. The BINAR main page 600 is an example of an application main page. After a user logs in, the users identity and affiliations are known. A start page that is customized for the particular user can thereby be presented. Here, Perry who is associated with contractor corp. is presented with a logo 601 and text 602 based on Perry's user preferences. The BINAR module has been selected 603 and a BINAR specific graphic 604 and navigation menu 605 presented. An application logo 606 is presented to identify the web based application. A seal of authenticity 607 identifies a certificate authority that helps authenticate the web based application and to secure communications. A content area 608 can hold information. In FIG. 6, the content area 608 presents a null daily message. A tools icon 609 is presented to Perry because he is an administrator. Users having different access levels could also, but are unlikely to, be presented with a tools icon. Similarly, Perry is presented with edit icons 611 for every module so he can edit.

Notice that the navigation bar has selections for “New Module” and “New Application”. These selections are typically presented only to administrators. Selecting “New Module” causes a blank module edit page to be presented to the user. Filling in the fields and accepting the edit page creates a new module. Similarly, new applications can be created.

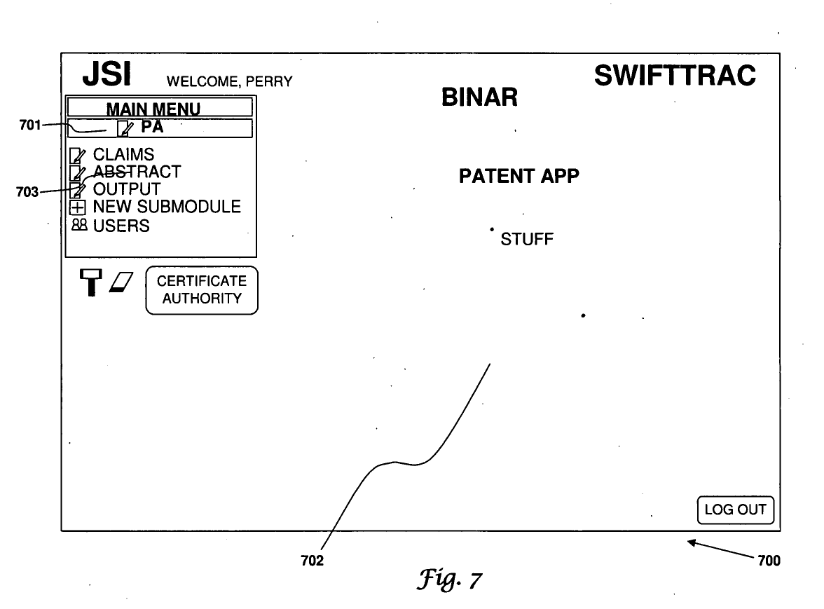

FIG. 7 illustrates the PA main page 700 in accordance with aspects of the embodiments. The PA main page 700 is an example of a module main page. The navigation menu 701 now indicates that Perry has moved into the PA module from the main menu. The page's content area 702 currently presents little information. The PA module has three submodules 703 called claims, abstract, and output.

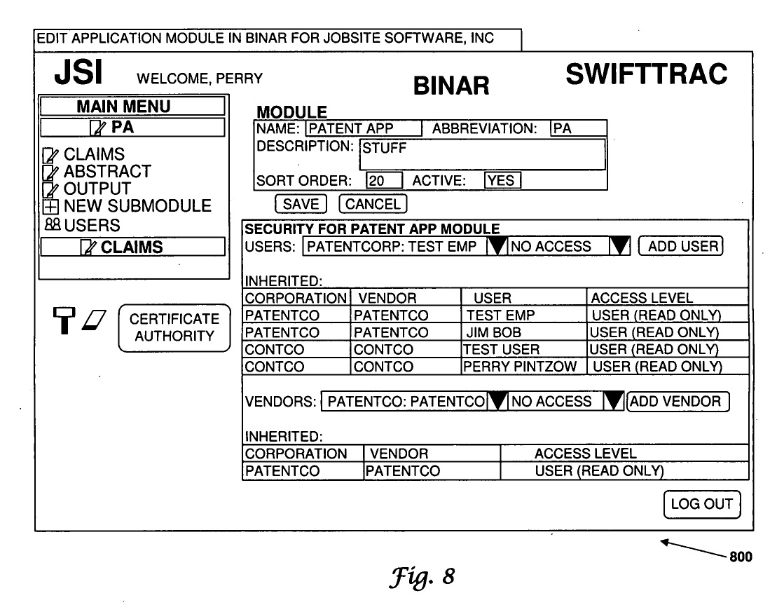

FIG. 8 illustrates the PA module edit page 800 in accordance with aspects of the embodiments. The PA module edit page 800 is an example of a module edit page. Perry can access this page by selecting the edit icon next to “PA” in the navigation bar. The module name is “Patent App” with abbreviation “PA” and description “stuff”. The contents of these fields can be presented in the module start page. The PA module can inherit users and vendors from BINAR. As such, the PA module has inherited two vendors and 13 users. Each user is associated with a vendor. For example, Perry works for Contractor, Inc. Each vendor can have a default access level that is automatically inherited by each of the vendor's employees although the access level can be set individually for each person. New users can be added to the list of those having access to the PA module. The PA module specific users need not have access to, or knowledge of, BINAR or any other BINAR module. Edits can be saved by selecting the “Save” button or cancelled by selecting the “Cancel” button.

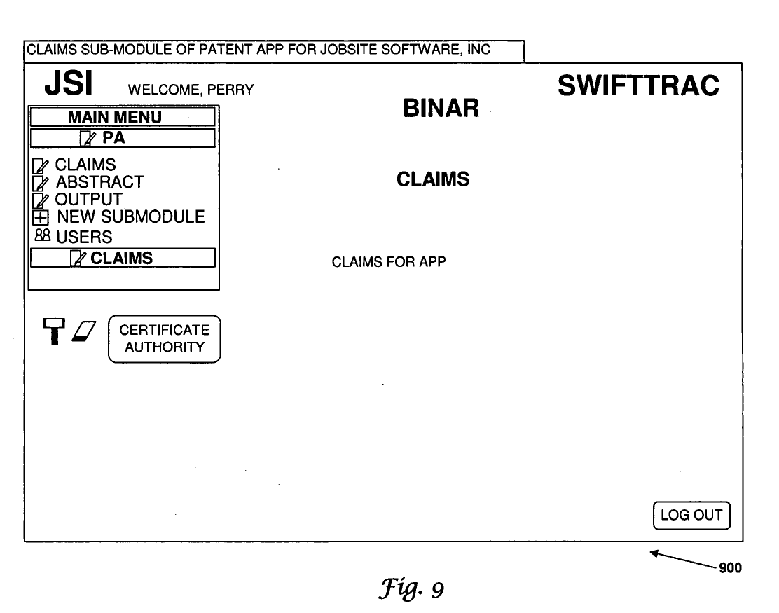

FIG. 9 illustrates the claims main page 900 in accordance with aspects of the embodiments. The claims main page 900 is an example of a submodule main page. The claims main page 900 can be access by selecting “claims” from the navigation bar.

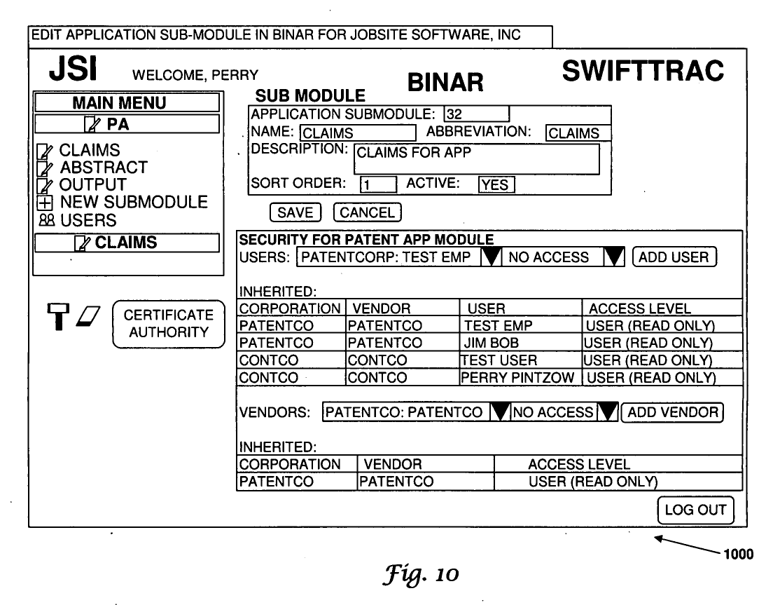

FIG. 10 illustrates the claims submodule edit page 1000 in accordance with aspects of the embodiments. The claims submodule edit page 1000 is an example of a submodule edit page. Notice the similarities between module edit pages as shown in FIG. 8, and submodule edit pages as shown in FIG. 10. They are similar because, in this case, the page customization module uses the same specification for formatting both pages. Different specifications would lead to the pages appearing differently. Notice the “Sort Order” field. Sort order indicated where on the navigation menu to place an item. As such, the claims submodule is first in the list under PA.

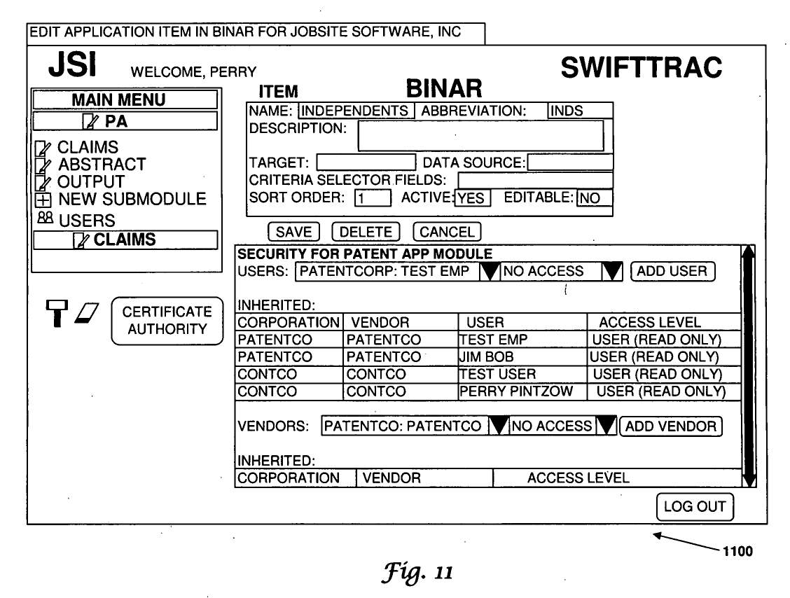

FIG. 11 illustrates a blank report edit page 1100 in accordance with aspects of the embodiments. A blank report edit page 1100 can be accessed by selecting “new item” in the navigation menu. The blank report edit page presents the target, data source, criteria selector fields. The target is the specific report to be produced. For example, data for the report can be set into a specific text format and emailed. The data source simply identifies where the data should be acquired from. For example, a relational database or web based service provider can be specified as the data source. Criteria selector fields is a data query specification. If the data source is an SQL database, then it can be search terms for an SQL query. If the data source is a web based service provider, then it can be text that can be formatted to the service provider's specifications. The desired result can be a list of data fields for presentation in a report specification page. The active box toggles the report's availability on and off.

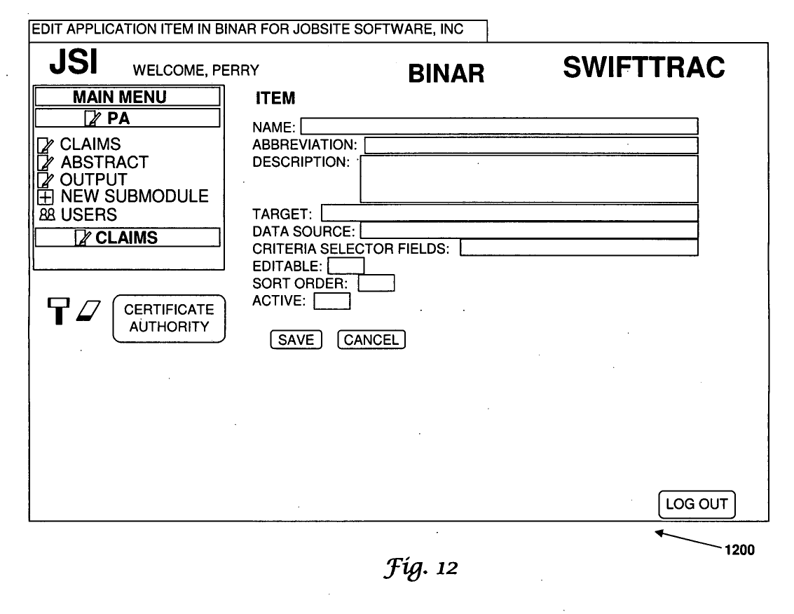

FIG. 12 illustrates the independents report edit page 1200 in accordance with aspects of the embodiments. The independents edit page 1200 is an example of a report edit page. The independents report edit page 1200 shown can be produced by filling fields into a blank page or by clicking the appropriate edit icon if the page already exists.

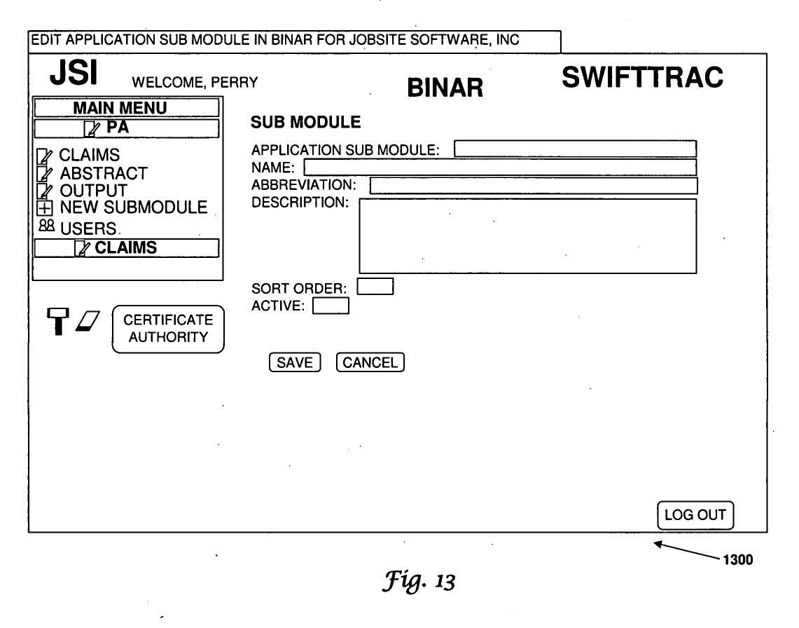

FIG. 13 illustrates a blank submodule edit page 1300 in accordance with aspects of the embodiments. A blank submodule edit page 1300 can be accessed by selecting “New Submodule” in the navigation bar.

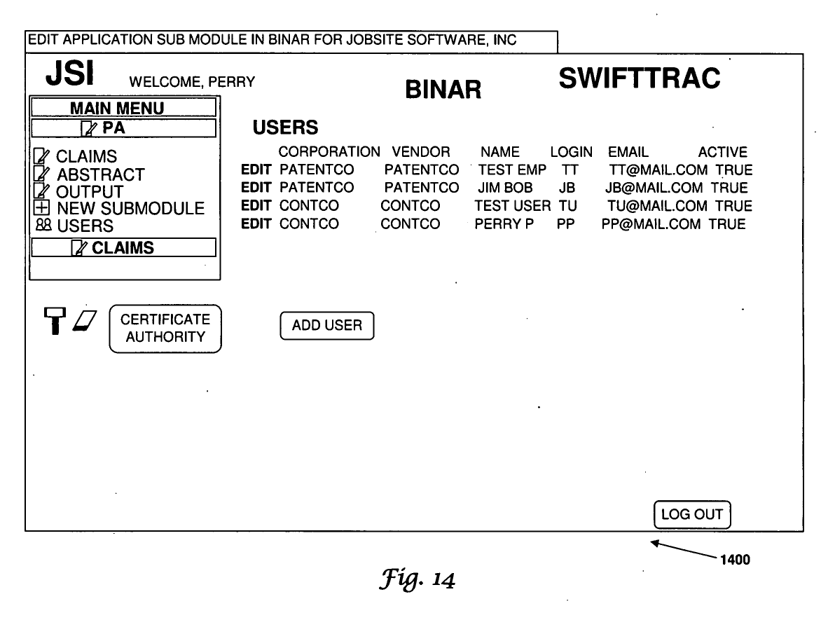

FIG. 14 illustrates a users edit page 1400 in accordance with aspects of the embodiments. Here, the PA module users are being edited. The users edit page can be accessed by selecting “Edit Users” in the navigation bar. Recall that PA inherited its users from BINAR. PA also inherited each users other information including access level from BINAR. The PA users can be edited such that the specific users have different names, associations, addresses, and access levels within the PA module. The PA specific data for each user need not propagate back to BINAR. This capability can be used to, for example, add PA administrators who are not also administrators for BINAR or other BINAR modules.

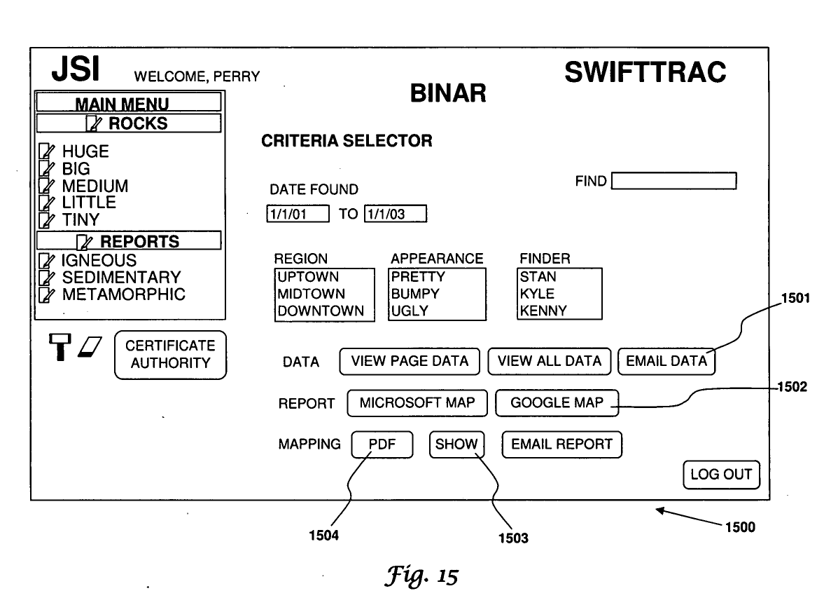

FIG. 15 illustrates a criteria selector page 1500 in accordance with aspects of the embodiments. A criteria selector page can be automatically created and formatted from database queries. For example, a first database query can request a list of indexed rows. The response can indicate that the rows are indexed by date found, region, appearance, and finder. Subsequent database queries can obtain date ranges, a list of regions, a list of appearances, and a list of finders. The automatically generated page can have an input, such as a menu or drop down list, for each indexed element. The inputs can be populated with selections from the subsequent queries.

A database query can also request a list of all the row names. Row names include the names of the indexed rows, such as region, appearance, and finder. The row headings also include the names of the non indexed rows such as rock name, latitude, and longitude. Mapping inputs 1502 can be presented to the user when the row names include latitude and longitude. Selecting one of the mapping inputs can cause mapping data to be submitted to a mapping web service, such as Google Maps or Microsoft Map, such that the service returns either a map graphic or map locator. A map locator can be a web uniform resource locator that a browser can use to obtain the map from the mapping service. Alternatively, the browser can receive the mapping data, submit the mapping data to the mapping service, and then obtain the map.

The user can also be presented with data viewing selections 1501 for viewing the data itself. Report selections 1503 can also be presented. A report format selection 1504 can specify the report format. Other selection can cause the report to be immediately displayed or to be emailed to a recipient.

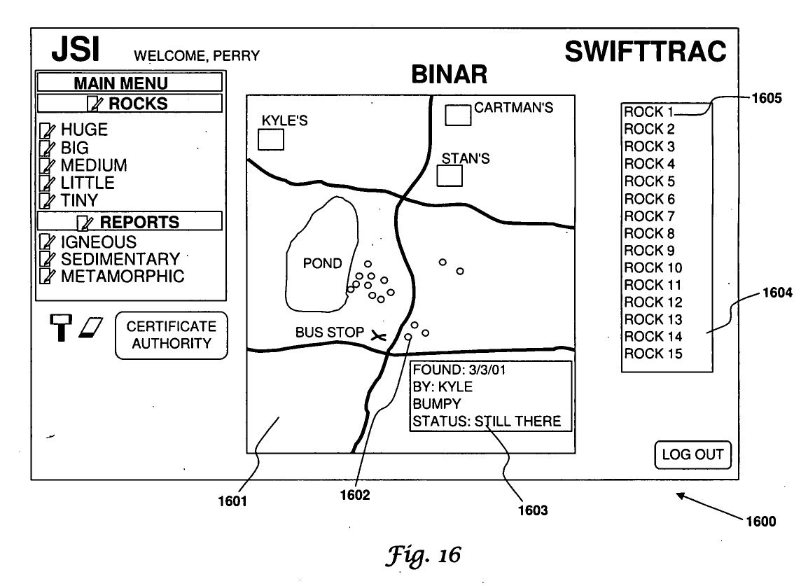

FIG. 16 illustrates a report page 1600 in accordance with aspects of the embodiments. The page illustrated has a map 1601 and a name field 1604. The map 1601 shows the locations of rocks superimposed on a map of a region. Mousing over a rock indictor 1602 can cause an information field 1603 to display. Similarly, mousing over a rock name 1605 can cause the information field 1603 to display. Selecting a rock indicator 1602 can cause the rock name 1605 to be highlighted. Similarly, selecting a rock name 1605 can cause the rock indicator 1602 to be highlighted and/or the information field 1603 to display as if the rock indicator had been moused over. Mousing over a graphic and selecting a graphic can be treated as interchangeable operations. In general, mousing over a field means positioning a cursor over a field. Selecting indicates a more deliberate action such as clicking or double clicking on a field.

The embodiments of the invention in which an exclusive property or right is claimed are defined as follows.

Having thus described the invention what is claimed is:

1. A system comprising:
a web server wherein a user associated with a client uses a web browser to access the web server to obtain a presentation;
a database engine managing at least one client table and at least one client data table associated with the at least one client table wherein the at least one client data table is indexed on at least one indexed element;
a client customization module that uses client presentation data to customize the presentation for the client; and
a page generation module that discovers a client data table's indexed elements and produces a criteria presentation comprising at least one criteria selection element for each of the client table's indexed elements.

2. The system of claim 1 further comprising a criteria selection module that uses user preferences to set the at least one criteria selection element to at least one initial criteria.

3. The system of claim 1 further comprising a user customization module wherein the user has a user type and wherein the user customization module interacts with the page generation module to customize the presentation based on the user type.

4. The system of claim 1 further comprising a security module wherein each user has an authenticator, wherein the authenticator comprises a fact, a characteristic, or a possession that authenticates the user's identity.

5. A system comprising:
a web server wherein a user associated with a client uses a web browser to access the web server to obtain a presentation;
a database engine managing at least one client table and at least one client data table associated with the at least one client table wherein the at least one client data table is indexed on at least one indexed element;
a client customization module that uses client presentation data to customize the presentation for the client;
a page generation module that discovers a client data table's indexed elements and produces a criteria presentation comprising at least one criteria selection element for each of the client table's indexed elements wherein the user accepts at least one user criteria from the criteria presentation; and
a reporting module that queries the database engine with a query comprising the at least one user criteria selection to obtain desired client data and thereby produces a report from the desired client data.

6. The system of claim 5 further comprising at least one report type module that formats the report.

7. The system of claim 6 wherein the report is formatted as an electronic mail message.

8. The system of claim 6 wherein the report is formatted as a document.

9. The system of claim 6 wherein the report is formatted as a web page.

10. The system of claim 6 wherein the report comprises audio data.

11. The system of claim 10 wherein the audio data is provided as a voice message.

12. The system of claim 5 further comprising a report automation module that triggers the reporting module to produce the report based on the at least one user criteria selection and wherein the report automation module triggers the reporting module upon the arrival of at least one reporting time or the elapsing of at least one reporting period.

13. The system of claim 5 wherein the at least one user criteria selection comprises a longitude and a latitude and wherein the report comprises a map.

14. A system comprising:
a web server wherein a user associated with a client uses a web browser to access the web server to obtain a presentation;
a database engine managing at least one client table and at least one client data table associated with the at least one client table wherein the at least one client data table is indexed on at least one indexed element;
a client customization module that uses client presentation data to customize the presentation for the client;
a page generation module that discovers a client data table's indexed elements and produces a criteria presentation comprising at least one criteria selection element for each of the client table's indexed elements wherein the user accepts at least one user criteria from the criteria presentation; and
a reporting module that queries the database engine with a query comprising the at least one user criteria selection to obtain desired client data and thereby specifies a report from the desired data;
wherein the report comprises a service provider data presentation if the desired client data comprises a flagged datum.

15. The system of claim 14 wherein the database engine obtains service provider data from a service provider and provides the service provider data to the reporting module and wherein the reporting module produces the service provider data presentation.

16 The system of claim 14 wherein the web server obtains service provider data from a service provider and embeds the service provider data within the report to thereby produce the service provider data presentation.

17. The system of claim 14 wherein the presentation comprises a service provider resource locator that directs the web browser to the service provider data presentation.

18. The system of claim 14 wherein the presentation comprises a web based application specifier that directs the web browser to obtain and run a web based application and wherein the web based application produces the service provider data presentation.

19. The system of claim 18 wherein the web based application accesses a service provider to obtain service provider data that is incorporated into the service provider data presentation.

20. The system of claim 14 wherein the at least one user criteria selection comprises a longitude and a latitude and wherein the report comprises a map.
